(19) United States
(12) Patent Application Publication
(10) Pub. No.: US 2005/0008209 A1
(43) Pub. Date: Jan. 13, 2005

(54) Image analysis apparatus, recording medium on which an image analysis program is recorded, and an image analysis method

(76) Inventor: Kazuhiko Matsumoto, Tokyo (JP)

Correspondence Address: LADAS & PARRY LLP, 224 SOUTH MICHIGAN AVENUE, SUITE 1200, CHICAGO, IL, 60604, US

(21) Appl. No.: 10/882,503

(22) Filed: Jul. 1, 2004

(30) Foreign Application Priority Data
Jul. 10, 2003 (JP) P2003-272976

(51) Int. Cl. G06K 9/00; G06K 9/36

(52) U.S. Cl. 382/128; 382/284; 382/154

(57) ABSTRACT

The object of the present invention is to provide an image-analysis apparatus that is capable of correlating and understanding organ function and tubular structure. The image-analysis apparatus performs image analysis based on image data, and comprises: a function-map-creation device which creates a function map based on function data that shows the functions of an organ; and an overlay device which correlates and overlays tubular-structure data for the tubular structure of the organ onto the function map.

### BACKGROUND OF THE INVENTION

1. Field of the Invention

This invention relates to an image-analysis apparatus that performs image analysis based on a function map.

2. Description of the Related Art

Conventionally, there has been an image-analysis method that uses a bullseye map created based on 3D image data of the heart as a device for analyzing the various functions of the heart (for example, refer to Japanese Laid-open patent application no. H08-146139).

With this analysis method using a bullseye map, it is possible to quantitatively display functions such as the wall movement of the heart.

On the other hand, by using an angiography apparatus and injecting a contrast medium into the blood vessels of the heart, it is also possible to geometrically analyze the state of the blood vessels. With this method, it is possible to find areas where there is narrowing of the blood vessels.

However, even when narrowing of the blood vessels is discovered using an angiography apparatus, there is a problem in that as a result of analyzing the heart functions (for example, heart wall movement) using a heart-function bullseye map, there are cases when function abnormality is not discovered, or conversely, even though an abnormal area such as an area of decreased functioning is found using a heart-function bullseye map, it may be difficult to know, for example, in which of the many coronary arteries surrounding the heart there is a problem.

Moreover, since there are individual differences in the shapes of coronary arteries, there is a problem in that accurate correlation of the coronary arteries on the heart-function bullseye map may not be possible.

Furthermore, even when an abnormality such as narrowing of a coronary artery is found, often other neighboring coronary arteries are developed and help with the blood flow, so there are cases when there are no effects such as a decrease in functioning of the heart due to abnormalities such as narrowing of the blood vessels, and since generally, surgery on coronary arteries puts a large burden on the patient's body, there is a strong demand to avoid observation through surgery as much as possible.

### SUMMARY OF THE INVENTION

Taking the above problems into consideration, it is the object of this invention to provide an image-analysis apparatus that is capable of correlating and gaining an understanding of organ function and tubular tissue structure.

(1) The above object of the present invention is accomplished by an image-analysis apparatus the performs image analysis based on image data such as 3-dimensional imaged data and 4-dimensional image data, and comprises: a function-map-creation device which creates a function map such as a heart-function bullseye map based on function data that shows the functions of an organ such as the heart, and an overlay device which correlates and overlays tubular-structure data for tubular structures such as blood vessels in the organ onto the function map.

According to the present invention, by having the overlay device overlay tubular-structure data such as coronary artery data onto the function map such as a heart-function bullseye map created by the function-map-creation device, it is possible to easily know which tubular structures such as blood vessels that surround an organ are supported by what locations of the organ, and thus it is possible to correlate and gain a better understanding of organ functions and tubular structure.

Moreover, by obtaining a function map and tubular structure data based on image data, it is possible to accurately correlate the tubular structure with the function map even though there are individual differences in the shape of the tubular structure.

(2) In one aspect of the present invention, the aforementioned image-analysis apparatus comprises: a function-setting device which sets the function data based on first data that contains voxel data for the voxels of the organ, and position data showing the position of the voxels; and where the function-map-creation device creates a function map based on reference-position data such as major-axis position data, apex position data and basal position data of the organ, and function data that is set by the function-setting device; and where the overlay function obtains and overlays tubular-structure data based on second data that contains path data such as coronary-artery-path data that shows the path of the tubular structure, and the reference-position data.

According to the present invention, by having the overlay device obtain and overlay tubular-structure data based on the reference-position data that is used when the function map is created, it is possible to correlate and overlay the tubular-structure data onto proper positions on the function map.

(3) In another aspect of the present invention, the aforementioned image-analysis apparatus comprises: a first judgment device which determines whether or not the first data and second data were obtained based on the same image data; and a display device such as a display unit that displays the overlay results by the overlay device; and where the display device displays the overlay results when it is determined that the first data and second data were obtained based on the same image data.

According to the present invention, by having the first judgment device determine whether or not the first data used when creating the function map, and the second data used when obtaining the tubular-structure data were extracted based on the same image data, it is possible to confirm that the tubular-structure data has been accurately overlaid onto the function map.

(4) In a further aspect of the present invention, the aforementioned image-analysis apparatus comprises a second judgment device, such as a control unit, that determines whether or not adjustment of the reference position is necessary; and where the display device displays the overlay result when it is determined by the second judgment device that adjustment of the reference position data is not necessary.

According to the present invention, the second judgment device determines whether or not adjustment of the reference-position data is necessary, so regardless of whether or not the first data and second data were extracted based on the same image data, when it is necessary to adjust the reference-position data, by performing adjustment and obtaining updated reference-position data, it becomes possible to accurately obtain correlated overlay results.

(5) In a further aspect of the present invention, the aforementioned image-analysis apparatus comprises an adjustment device, such as a position-data-adjustment unit that adjusts the reference-position data and obtains updated reference-position data; and where when the second judgment device determines that adjustment of the reference-position data is necessary, the adjustment device obtains updated reference-position data and then the overlay device obtains and overlays tubular-structure data again based on the updated reference-position data.

According to the present invention, even when adjustment of the reference-position data is necessary, by having the adjustment device adjust the reference-position data, it becomes possible to perform corrective adjustment of the overlay even when rotation shifting or the like occurs in the overlay results.

(6) In a further aspect of the present invention, in the aforementioned image-analysis apparatus the adjustment device obtains updated reference-position data based on the position-adjustment data that is obtained based on the image data for the organ and tubular structure.

According to the present invention, by having the adjustment device obtain updated reference-position data based on position-adjustment data for at least two points, such as base points of the tubular structure of the organ, for example the base of two coronary arteries that branch off from the aorta, or points that are obtained by placing man-made objects as landmarks on the body beforehand, it becomes possible to perform corrective adjustment of the overlay even when rotation shifting or the like occurs in the overlay results.

(7) In a further aspect of the present invention, the aforementioned image-analysis apparatus comprises an abnormality-notification device which notifies of abnormalities based on the overlay results by the overlay device, the abnormal areas of tubular structure such as narrowing of blood vessel in the tubular structure indicated by the tubular-structure data, and areas of abnormal function such as a decrease in functioning indicated by the function map.

According to the present invention, when the distance between an abnormal area due to narrowing of a blood vessel or the like and an abnormal area found on the heart-function bullseye map is less than a specified distance, by having the abnormality-notification device display in color or highlight the color of the abnormal areas, or output a sound when a cursor is moved above the abnormal areas on the screen, it becomes possible to accurately notify of abnormal areas.

(8) In a further aspect of the present invention, in the aforementioned image-analysis apparatus, the function map is a bullseye map such as a heart-function bullseye map.

According to the present invention, together with displaying the function of an organ as a 2-dimensional image map, it is possible to overlay and display tubular-structure data on this 2-dimensional map.

(9) In a further aspect of the present invention, in the aforementioned image-analysis apparatus, the function map is a 3D polygon model.

According to the present invention, together with displaying the organ functions as a 3-dimensional image map, it becomes possible to overlay and display tubular-structure data on this 3-dimensional map.

(10) The above object of the present invention is accomplished by having a computer, which is included in an image-analysis apparatus that performs image analysis based on 3-dimensional image data or 4-dimensional image data, function as: a function-map-creation device which creates a function map such as a heart-function bullseye map based on function data that indicates the functions of an organ such as a heart; and an overlay device that correlates and overlays tubular-structure data for the tubular structure such as the blood vessels of an organ onto the function map.

(11) The above object of the present invention is accomplished by an image-analysis method of performing image analysis based on image data such as 3-dimensional image data or 4-dimensional image data, and comprising: a function-setting process for setting function data that indicates the functions of an organ based on first data that contains voxel data for the voxels of an organ such as the heart, and position data showing the position of the voxels; a function-map-creation process for creating a function map such as a heart-function bullseye map based on reference-position data such as the major-axis data, apex position data and basal position data of the organ, and function data; a tubular-structure-acquisition process for obtaining tubular-structure data based on second data that contains path data that indicates the path of the tubular structure such as blood vessels in the organ; and an overlay process for correlating and overlaying the tubular-structure data onto the function map.

### BRIEF DESCRIPTION OF THE DRAWINGS

FIG. 1 is a block diagram showing the major construction of the image-analysis apparatus of this invention.

FIG. 2A is a drawing explaining the various positional data of a 3D image of the heart.

FIG. 2B is a table showing 3D image data.

FIG. 3 is an explanation drawing of a heart function bullseye map.

FIG. 4 is an explanation drawing that gives an example of heart function indicators.

FIG. 5 is an explanation drawing showing a coordinate conversion table.

FIG. 6 is an explanation drawing showing a heart function indicator definition table.

FIG. 7 is an explanation drawing showing a heart function bullseye map coordinate table.

FIG. 8 is an explanation drawing showing a function map table.

FIG. 9A is an explanation drawing of the introduction of cross sections.

FIG. 9B is and explanation drawing of the mth cross section.

FIG. 10 is an explanation drawing showing a bullseye coordinate system.

FIG. 11 is a flowchart showing the operation for creating a coordinate conversion table.

FIG. 12 is a flowchart showing the operation for creating a heart function bullseye map.

FIG. 13 is an explanation drawing of a heart function bullseye map showing the heart wall movement function.

FIG. 14A is a drawing showing a 3D image that was obtained based on 3D image data.

FIG. 14B is an explanation drawing of a 3D image of coronary arteries.

FIG. 14C is an explanation drawing of coronary artery data that is converted to bullseye map coordinates.

FIG. 15 is a flowchart for obtaining coronary artery data.

FIG. 16 is a flowchart showing the overlaying process.

FIG. 17 is a flowchart showing the overlaying process.

FIG. 18A is an explanation drawing of the overlay results.

FIG. 18B is an explanation drawing of the overlay results.

FIG. 19 is an example of a display image on the display unit that displays the overlay results.

### DESCRIPTION OF THE PREFERRED EMBODIMENTS

The preferred embodiments of the invention will be explained below using the drawings.

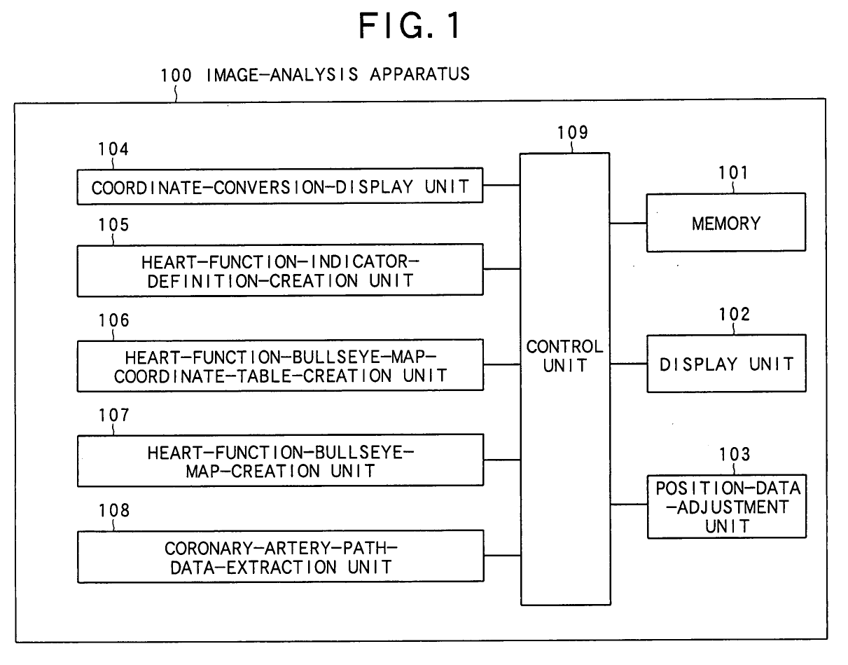

FIG. 1 is a block diagram showing the main construction of the image-analysis apparatus.

The image apparatus 100 comprises: a memory 101, a display unit 102 that serves as a display device and a abnormality-notification device; a position-data-adjustment unit 13 that serves as an adjustment device; a coordinate-conversion-table-creation unit 104; a heart-function-indicator-definition-table-creation unit 105 and heart-function-bullseye-map-coordinate-table-creation unit 106 that serves as a function-setting device; a heart-function-bullseye-map-creation unit 107 that serves as a function-map-creation device; a coronary-artery-path-data-extraction unit 108 the serves as an overlay device; and a control unit 109 that serves as a function-map-creation device, overlay device, function-setting device, display device, first and second judgment device, adjustment device, abnormality-notification device and computer.

The memory 101 comprises a well-known memory device such as a hard-disc drive, magnetic-disc drive or optical-disc drive; and 4-dimensional image data H4D, which is image data for the left ventricle of the heart, and which is obtained from heart slice images taken by a CT (Computed Tomography) apparatus or the like, is stored in the memory 101 beforehand.

This 4-dimensional image data H4D contains the operation of the expansion/contraction over time of the heart as phase P, which is Z number of time elements, and contains a plurality of voxel data for the left ventricle in a 3-dimensional space at a time indicated by that phase P as 3-dimensional image data HP.

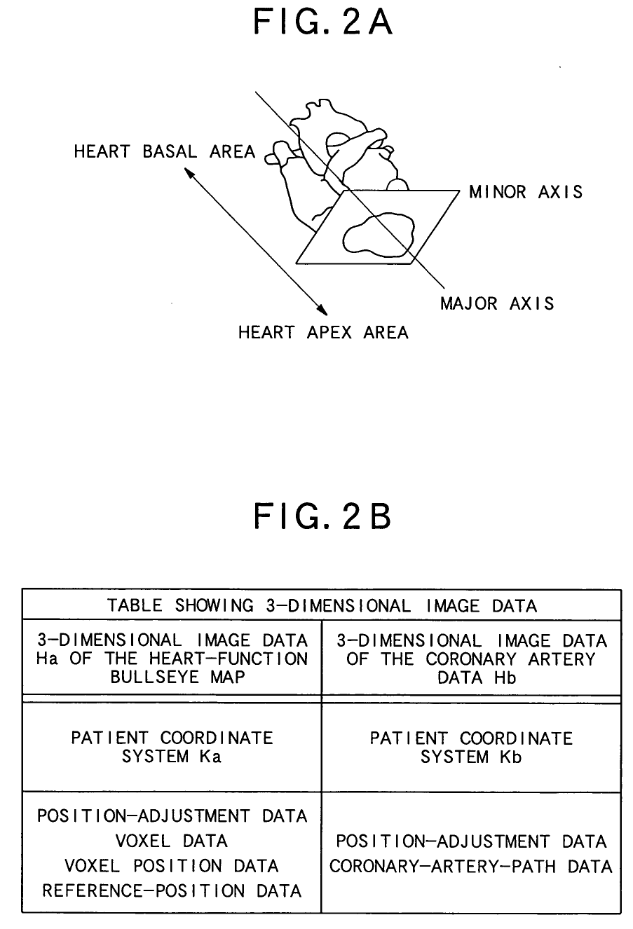

FIG. 2A is an explanation drawing of the various position data of a 3D image of the heart. FIG. 2B shows the 3D image data Ha and 3D image data Hb that are stored in the memory 101.

First, the 3-dimensional image data HP contains: a plurality of slice images taken by a CT apparatus or the like; various position data for expressing the geometrical structure of the heart, or more particularly, a plurality of voxel data for a 3D image of the left ventricle as first data; major-axis position data for the left ventricle, cardiac apex position data indicating the position of the apex of the heart, and base position data indicating the position of the base of the heart as reference-position data in the patient coordinate system Ka. In other words, the memory 101 stores Z number of phases P, and 3-dimensional image data HP that corresponds to the phases P.

Normally, it is not possible to obtain all of the 3-dimensional image data HP that corresponds to one phase P in one CT (Computed Tomography) image. Actually, in one CT image it is impossible to obtain images of the entire target object, so images are taken of the target object over several times from various directions and locations. In other words, the exact imaging time of the voxel data of one 3-dimensional image HP can be said to differ for each direction or location from which an image can be taken for one CT image.

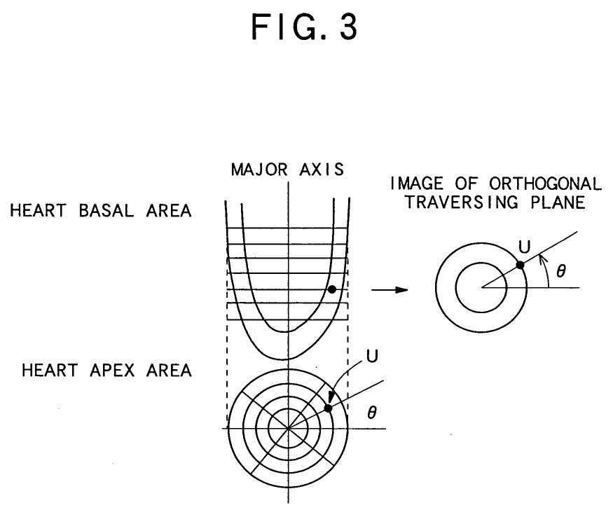

Here, the bullseye map will be explained using FIG. 2A, FIG. 2B and FIG. 3.

The bullseye map M is a method of displaying the heart as a 2-dimensional image by arranging cross-sectional images of traversing planes that are perpendicular to the major axis onto concentric circles based on the 3-dimensional data Ha that contains the voxel data or first heart data, and voxel position data.

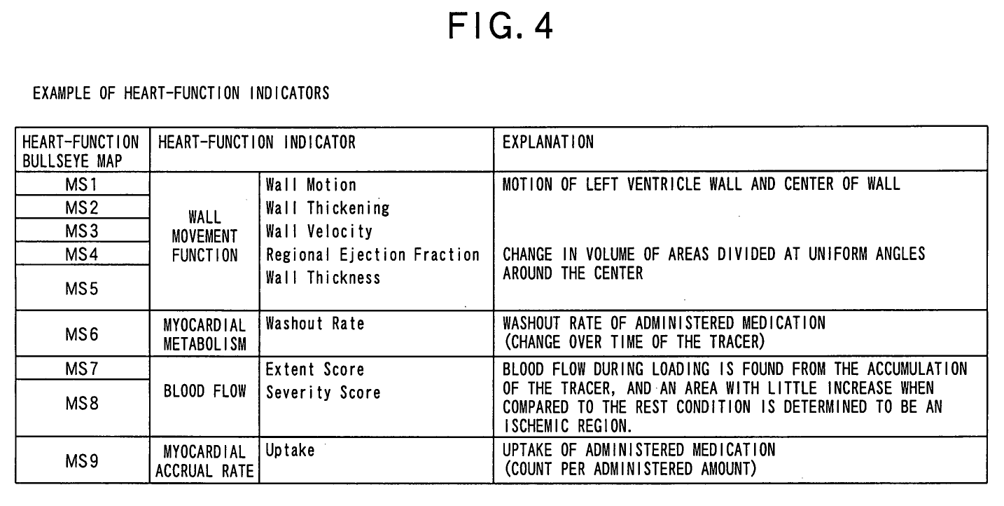

This bullseye map M is created for each heart function that shows the various operations and conditions of the heart. This kind of bullseye map M that shows the heart functions is called a heart-function bullseye map MS, and for example, as shown in FIG. 4, heart-function bullseye map MS1 is a bullseye map that shows the motion of the wall surface or center of the wall in the left heart ventricle that is used as a heart-function indicator when analyzing the movement function of the left ventricle; and heart-function bullseye map MS9 is a bullseye map that shows the myocardial accrual rate that is used as a heart-function indicator when analyzing the uptake of administered radiopharmaceutical.

Furthermore, position-adjustment data is also stored in 3-dimensional image data. When a heart-function bullseye map MS and coronary artery data C are obtained based on separate 3-dimensional image data Ha and 3-dimensional image data Hb, position-adjustment data is also obtained from the respective image data. At least two points are used from among characteristic areas of the body, such as the base of two coronary arteries that branch off from an artery, as the positions that are the reference points for this position-adjustment data.

By adjusting the reference-position data based on the position-adjustment data in this way, it becomes possible to perform overlay accurately when a heart-function bullseye map MS and coronary artery data C are obtained from separate 3-dimensional image data, even when rotational shifting occurs.

The display unit 102, together with the control unit 109, functions as a display device and abnormality-notification device, and comprises a CRT (Cathode Ray Tube) monitor, liquid-crystal monitor or the like, and it displays the heart-function bullseye map MS, or the results of overlaying coronary artery data over the heart-function bullseye map MS as will be described later. Also, it is used for performing abnormality notification by displaying abnormal areas in color, according to an abnormal area of a coronary artery, or abnormal area displayed on the heart-function bullseye map.

The position-data-adjustment unit 103, together with the control unit 109, serves as an adjustment device, and it detects any shift in position based on the position-adjustment data for the heart-function bullseye map MS and coronary artery data C that are stored in the memory 101, then adjusts the reference-position data so that it overlaps enough for diagnosis to be possible, and obtains new updated reference-position data in order that the heart-function bullseye map MS and coronary artery data C are overlaid in an accurate positional relationship.

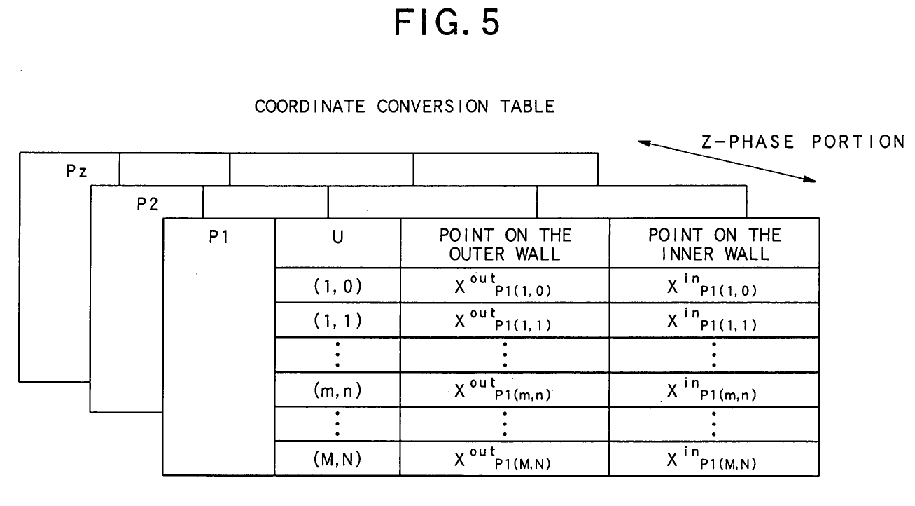

The coordinate-conversion-table-creation unit 104 is used for finding the coordinate system of the bullseye map, and it creates a coordinate-conversion table (see FIG. 5) as will be described later based on the 4-dimensional image data H4D stored in the memory 101.

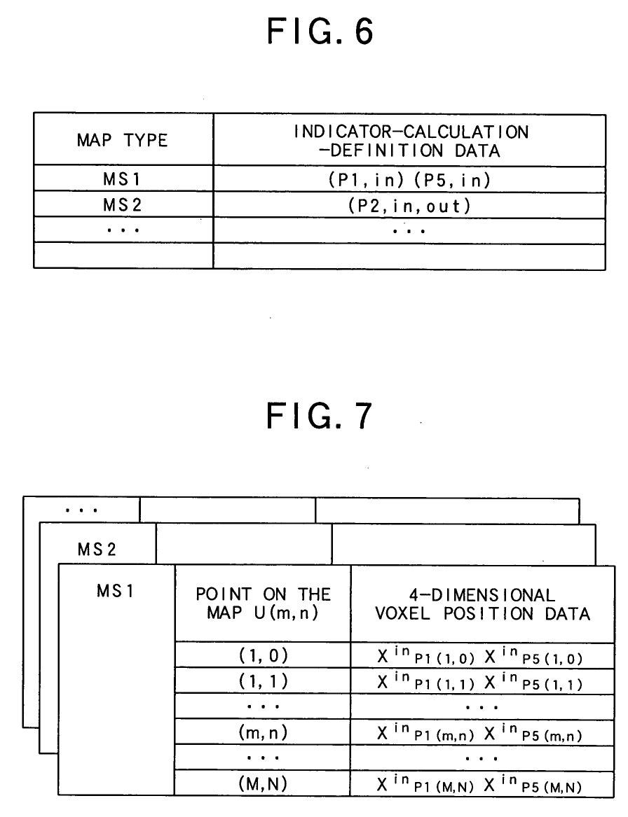

The heart-function-indicator-definition-table-creation unit 105, together with the heart-function-bullseye-map-coordinate-table-creation unit 106 and control unit 109, serves as a function setting device, and in order to create a heart-function bullseye map MS for displaying a desired heart function, it creates a heart-function-indicator-definition table (see FIG. 6) that defines indicator-calculation-definition data that will be described later.

The heart-function-bullseye-map-coordinate-table-creation unit 106, together with the heart-function-indicator-definition-table-creation unit 105 and control unit 109, serves as a function setting device, and creates a heart-function-bullseye-map-coordinate table (see FIG. 7) that shows voxel position data (hereafter referred to as 4D voxel position data) in the 4-dimensional image data H4D that is used for calculating a heart-function-indicator value a at a point U on the heart-function bullseye map MS based on the indicator-calculation-definition data that is used in the indicator calculation defined by the heart-function-indicator-definition table (see FIG. 6). The creation procedure will be described later.

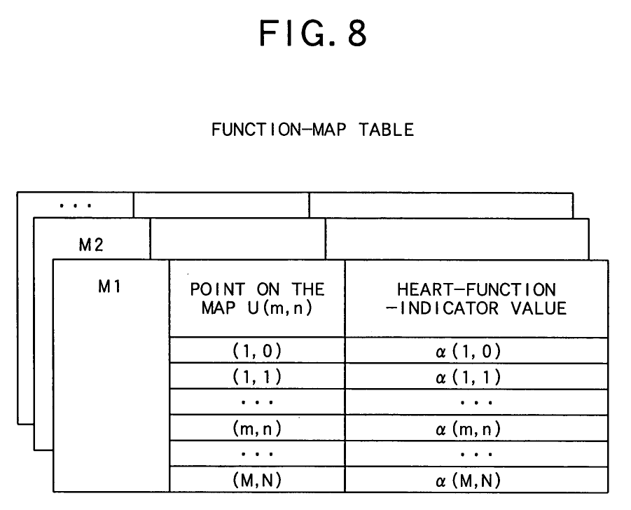

The heart-function-bullseye-map-creation unit 107, together with the control unit 109, serves as a function-map-creation device, and it calculates the heart-function-indicator values a at all points U on the heart-function bullseye map MS based on the heart-function-bullseye-map-coordinate table (see FIG. 7), and creates a function-map table (see FIG. 8) , then creates a heart-function bullseye map MS based on this function-map table (see FIG. 8).

The coronary-artery-path-data-extraction unit 108, together with the control unit 109, serves as an overlay function, and it extracts path data from the 3-dimensional image data Hb stored in the memory 101 as second data for all of the blood vessels V. Then, together with the control unit 109, it calculates the coordinate components r and θ for points Q on the blood vessel V paths.

The control unit 109 comprises a CPU (Central Processing Unit) having an operational function, ROM (Read Only Memory) that stores various programs (including an image-analysis program) and data, and RAM (Random Access Memory) as a work memory; and it controls all of the component elements of the image-analysis apparatus 100. Moreover, by executing an image-analysis program that is recorded on a recording medium that can be read by an image-analysis apparatus as a computer, the control unit 109 functions as the map-creation device, overlay device, function-setting device, display device, first and second judgment device, adjustment device and abnormality-notification device which the invention.

(1) Creating the Heart-Function Bullseye Map

Next, the procedure for creating the coordinate-conversion table (see FIG. 5) for creating the bullseye map M coordinates from the 4-dimensional image data H4D is explained.

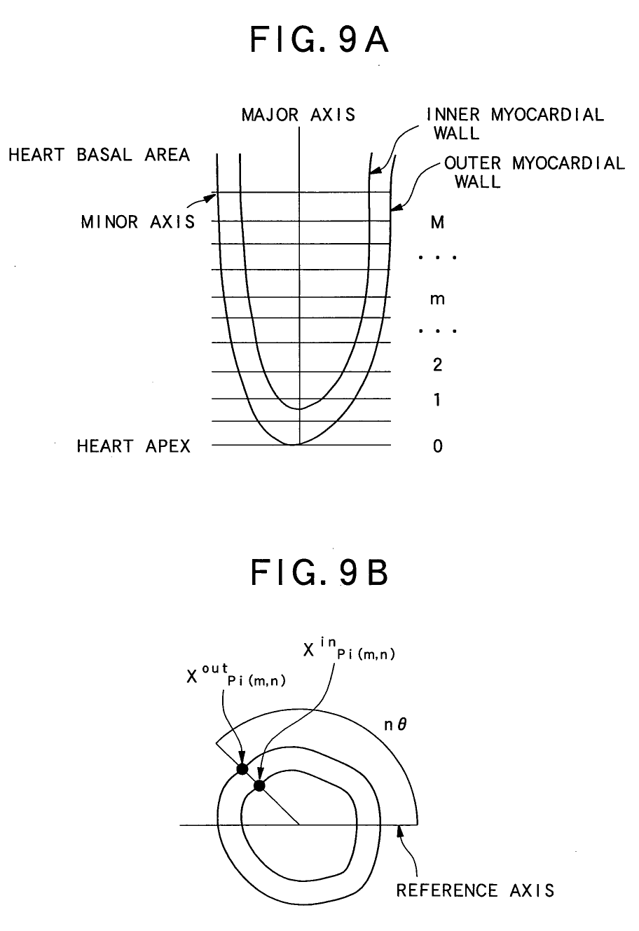

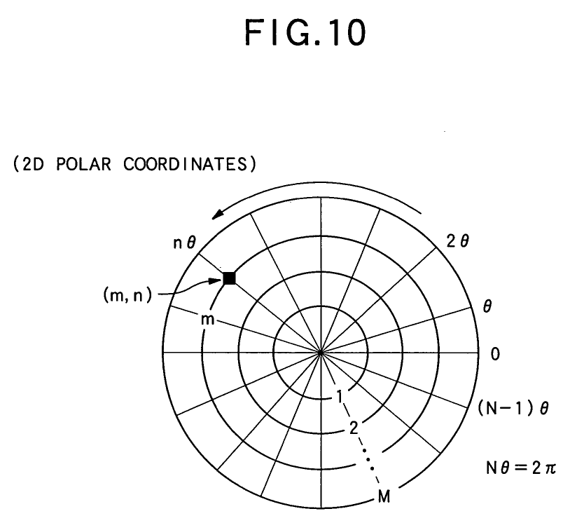

FIG. 9A and 9B are explanation drawings showing the coordinate system for a 3-dimensional image, and FIG. 10 is an explanation drawing showing the coordinate system of the bullseye map.

The 3-dimensional image data HPz corresponding to an arbitrary phase Pz that is stored in the memory 101 contains a plurality of voxels of the 3-dimensional image, and major-axis position data for the left ventricle, heart apex position data and heart basal position data as reference position data in the patient coordinate system Ka.

Also, an M number of cross sections that are perpendicular to the major axis are introduced between the heart apex area and heart basal area based on the reference position data (see FIG. 9A) . Each cross section has 2-dimensional polar coordinates centered around the major axis, and the position nθ from the reference axis on the mth cross section from the heart apex can be expressed as (m, n) (see FIG. 9b) . In other words, the center section of the bullseye map corresponds to the heart apex, and near the circumference of the bullseye map corresponds to the base of the heart.

On the other hand, since the bullseye map M is expressed by arranging cross-sectional images of traversing planes that are perpendicular to the major axis onto concentric circles, or slices, the coordinates of points U on this bullseye map M can also be expressed in the same coordinates (m, n) (see FIG. 10).

Therefore, when position data for points U on the bullseye map M is taken to be map position data U (m, n), voxel position data for the outer myocardial wall, and the voxel position data for the inner myocardial wall of the corresponding 3-dimensional image data HPz, can be obtained as outer myocardial wall position data X^{out}_{Pz (m, n)} and inner myocardial wall position data Xⁱⁿ_{Pz (m, n)}.

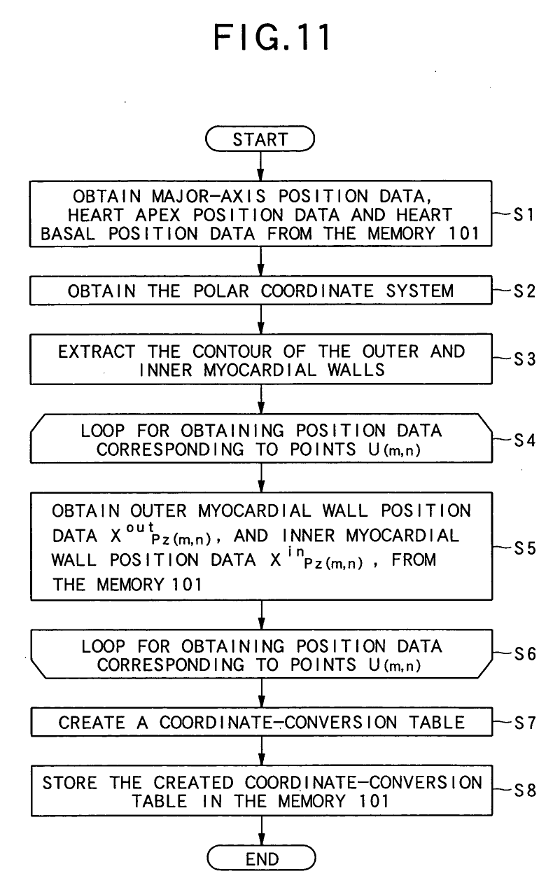

Next, the flowchart shown in FIG. 11 will be used to explain the operation of creating a bullseye-map-coordinate-conversion table from the 4-dimensional image data H4D.

First, the control unit 109 obtains the major-axis position data for the left ventricle, heart apex position data and heart basal position data of the 3-dimensional image data HPz for phase Pz based on the data stored in the memory 101 (step S1).

Next, the control unit 109 obtains cross section m that is perpendicular to the major axis and the polar coordinate system (m, n) centered on the major axis with respect to that cross section based on the data obtained in step S1 (step S2).

Next, the control unit 109 extracts the contour of the outer myocardial wall and inner myocardial wall from the plurality of voxel data of the 3-dimensional image (step S3)

Also, the control unit 109 starts the process for creating the coordinate-conversion-table for all of the points U on the bullseye map M (step S4).

In the coordinate-conversion-table-creation process, first, based on the 3-dimensional image data HPz for the phase Pz that corresponds to the map position data U(m, n) at the point U on the bullseye map M stored in the memory 101, the control unit 109 obtains the voxel position data for the outer myocardial wall point and the voxel position data for the inner myocardial wall point as the outer myocardial wall position data X^{out}_{Pz (m, n)} and the inner myocardial wall position data Xⁱⁿ_{Pz (m, n)}, respectively (step S5).

After the outer myocardial wall position data X^{out}_{Pz (m, n)} and the inner myocardial wall position data Xⁱⁿ_{Pz (m, n)} have been obtained for all of the points U on the bullseye map M (step S6) , the coordinate-conversion-table-creation unit 104, according to control from the control unit 109, creates a coordinate-conversion table based on the obtained data (see FIG. 5) (step S7).

Also, the control unit 109 stores the created coordinate-conversion table in the memory 101 (step S8). The above process is similarly performed for all phases P, and the process ends after coordinate-conversion tables are created and stored in the memory for just the number of phases, or in other words for z number of phases.

Next, heart-function definitions that define specific heart-function indicators for a bullseye map having a coordinate system based on the created coordinate-conversion tables will be explained.

FIG. 6 is an explanation drawing of a heart-function-indicator-definition table.

The heart-function-indicator-definition table (see FIG. 6) is a table that defines image data from the 4-dimensional image data H4D that is used for indicator calculation as indicator-calculation-definition data, such as {phase number, outer-wall-position data, and/or inner-wall-position data}.

Here, the indicator calculation is an operation for finding a heart-function-indicator value α, which is data indicating a heart function, and the heart-function-indicator value α at a point U on the heart-function bullseye map MS is calculated based on the defined indicator-calculation-definition data.

When heart-function bullseye map MS1 is a map showing the movement of the heart wall, the heart-function-indicator-definition-table-creation unit 105 defines the indicator-calculation-definition data to be used in that indicator calculation as {P1, in} and {P5, in} and creates the heart-function-indicator-definition table shown in FIG. 6.

With this heart-function-indicator-definition table, the heart-function-indicator value a of the heart-function bullseye map MS1 is calculated based on the voxel-group data positioned according to the inner-myocardial-wall-position data Xⁱⁿ_{P1} for the expansion phase P1, and the inner-myocardial-wall-position data Xⁱⁿ_{P5} for the contraction phase P5.

Similarly, when the heart-function bullseye map MS2 is a map that shows the wall thickness of the heart, the indicator-calculation-definition data used for that indicator calculation is defined as {P2, out, in}, and according to this, the heart-function-indicator value a of the heart-function bullseye map MS2 is calculated based on the voxel-group data positioned according to the outer-myocardial-wall-position data X^{out}_{P2} and inner-myocardial-wall-position data Xⁱⁿ_{P2} for phase P2 that gives the optimal condition for heart-wall measurement.

This heart-function-indicator-definition table can be stored beforehand in the memory 101. Also, based on the indicator-calculation-definition data in the heart-function-indicator-definition table (see FIG. 6), the heart-function-bullseye-map-coordinate-table-creation unit 106 creates a heart-function-bullseye-map-coordinate table (see FIG. 7) that shows the 4-dimensional voxel position data to be used for calculating the heart-function-indicator value a at point U on the heart-function bullseye map MS. The operation of creating the heart-function bullseye map based on the created heart-function-bullseye-map-coordinate table is explained below.

The heart-function bullseye map MS is created based on the heart-function-bullseye-map-coordinate table (see FIG. 7) by calculating the heart-function-indicator values α (m, n) at points U(m, n) on the heart-function bullseye map MS and obtaining the heart-map table shown in FIG. 8.

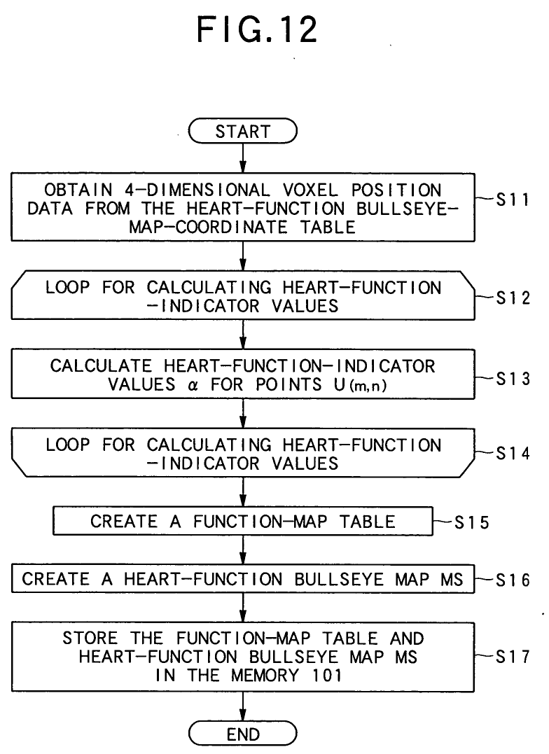

The operation for creating the heart-function bullseye map MS will be explained using the flowchart shown in FIG. 12. The process described below is executed by the control unit 109 and other units based on control from the control unit 109.

First, the control unit 109 obtains the 4-dimensional voxel position data to be used in the indicator calculation of the heart-function bullseye map MS based on the heart-function-bullseye-map-coordinate table (see FIG. 7) (step S11).

Next, based on the obtained 4-dimensional voxel position data, the control unit 109 calculates the heart-function-indicator values α (m, n) at points U(m, n) on the heart-function bullseye map MS. More specifically, the control unit 109 calculates the heart-function-indicator values α (m, n) at points U(m, n) based on the voxel data of the 4-dimensional image data H4D expressed by the 4-dimensional voxel position data (step S12, step S13). After the heart-function-indicator values a have been calculated for all of the points U on the heart-function bullseye map MS, the process moves to step S15 (step S14).

The heart-function-bullseye-map-creation unit 107 creates a function-map table (see FIG. 8) based on the calculated heart-function-indicator values a (step S15) and then creates the heart-function bullseye map MS based on this function map (step S16).

Also, the control unit 109 stores the created function-map table and heart-function bullseye map MS in the memory 101 and ends processing (step S17).

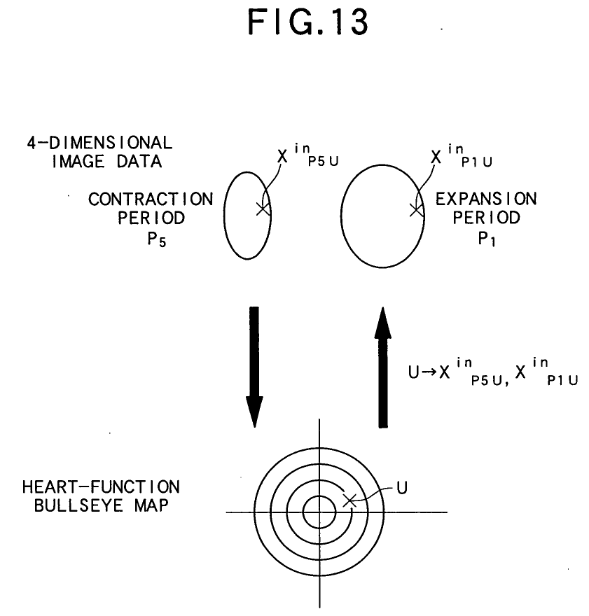

FIG. 13 is a heart-function bullseye map MS that shows the heart wall movement function and that was created by the procedure described above based on the heart-function-indicator table (FIG. 6).

In heart-function bullseye map MS1 that shows the heart-wall-movement function that shows distance of movement of the heart wall, the heart-function indicator at an arbitrary point U on that map is calculated based on the indicator-calculation-definition data {P1, in}, {P5, in}.

In other words, the indicator-calculation-definition data that corresponds to a point U on the heart-function-bullseye map MS1 corresponds to voxels containing inner myocardial wall position data Xⁱⁿ_{P1U} of the expansion phase P1 and inner myocardial wall position data Xⁱⁿ_{P5U} contraction phase P5. In this way, points on a heart-function bullseye map showing movement function or the like correspond to points on a plurality of 3-dimensional images of different phases. In this way, it is possible to create various heart-function bullseye maps MS from the 4-dimensional image data.

The 4-dimensional image data can be stored beforehand in the memory 101 that is installed in the apparatus, however is not limited to this, and construction is possible in which a recording medium can be mounted in the apparatus, and the data can be stored on that recording medium, or construction is also possible in which the data can be stored in a memory device that is capable of communication with the apparatus.

Furthermore, together with being possible to set a plurality of functions from the data of one image, comparative observation of a plurality of function maps that correspond to this plurality of functions has the effect of making it easier to discover disorders or the progressive state after an operation by comprehensively evaluating the plurality of indicators obtained from the data of one image.

Furthermore, by normalizing the distribution of heart-function indicator values α, using the heart-function bullseye map as a measure, it becomes possible to perform comparison between a plurality of 4-dimensional images on the heart-function bullseye map. For example, it has the effect of making it easy to perform comparison between the cases of a plurality of persons, such as comparisons between the heart-function bullseye maps of healthy individuals and the heart-function bullseye maps of patients.

(2) Process of Obtaining Coronary Artery Data

Next, the process for obtaining coronary artery data, which has been converted to bullseye map coordinates, from coronary artery path data that has been obtained from 3-dimensional image data will be explained.

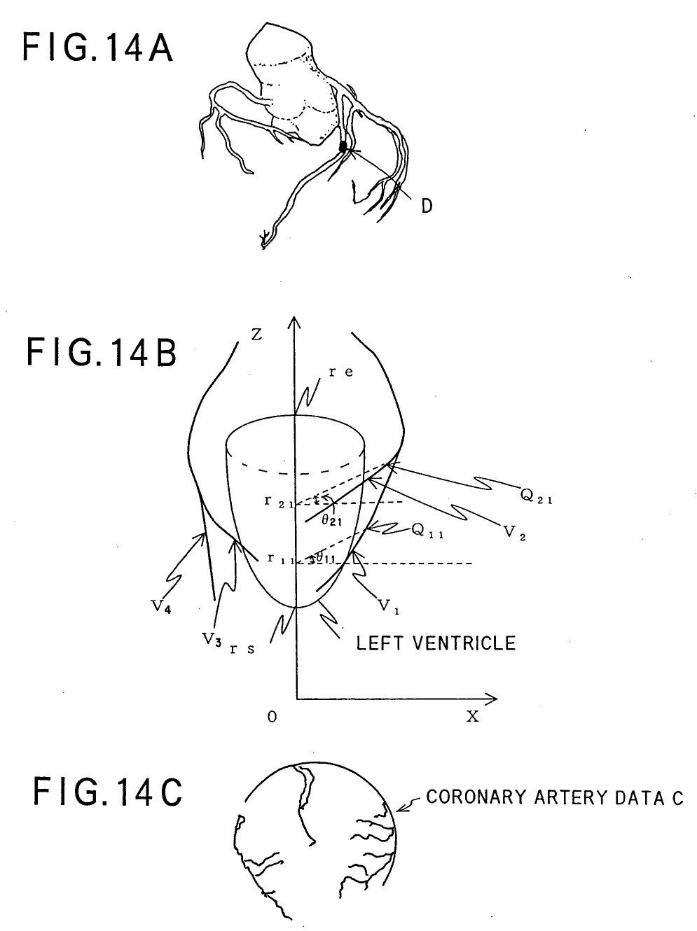

FIG. 14A is a 3-dimensional image that is obtained based on 3-dimensional image data. FIG. 14B is an explanation drawing of a 3-dimensional image of coronary arteries. FIG. 14C is an explanation drawing of coronary artery data C that has been converted to bullseye map coordinates. In the figures, point D can be confirmed as being a location of narrowing.

The 3-dimensional image data Hb for the coronary arteries is stored in the memory 101. This 3-dimensional image data Hb for the coronary arteries contains the patient coordinate system Kb, and contain path data as second data. This path data expresses the state of the path of the coronary arteries, and contains data such as that showing narrowing of a coronary artery.

The patient coordinate system referred to here is a relative coordinate system that is defined according to the position of the imaging apparatus and patient when taking an image, and the shift in the posit-ion of the imaging table.

Imaging for obtaining 3-dimensional image data Hb for creating map coordinates for the coronary arteries may differ from imaging for obtaining 3-dimensional image data Ha for creating the heart-function bullseye map described, such as in the position of the patient when taking an image, the imaging apparatus etc. In this case, in the coronary artery map coordinate conversion, position data in the patient coordinate system Kb which is different than the position data in the patient coordinate system Ka when creating the heart-function bullseye map is obtained, so when overlaying the coronary artery data over the heart-function bullseye map, it is necessary to adjust the shift in that overlay an amount such that diagnosis is possible. Overlaying the coronary artery data C over the heart-function bullseye map will be described later.

First, the coronary-artery-path-data-extraction unit 108 extracts path data (path state) from the 3-dimensional image data H for all of the blood vessels V.

Next, based on the extracted path data, all of the points Q of the blood vessel V path are converted to map coordinates defined by coordinates (r, θ). Here, r is the major axis component and is the distance in the Z-axis direction in the patient coordinate system Kb, and θ is the angle made taking the minor axis that is orthogonal to the major axis as a reference. In FIG. 14B, the coordinate components for point Q₁₁on blood vessel V₁ are obtained as (r₁₁, θ₁₁) , and the coordinate components for point Q₂₁ on blood vessel V₂ are obtained as (r₂₁, θ₂₁).

In this way, the control unit 109 performs map coordinate conversion for all of the points Q for all of the blood vessels V extracted by the coronary-artery-path-data-extraction unit 108, and obtains coronary artery data C as tubular structure data. The number of points Q can be enough such that it is possible to know the path state (path data) of the blood vessels. For example, it is preferable that the spacing between points Q be smaller than the width of the narrow section to be observed.

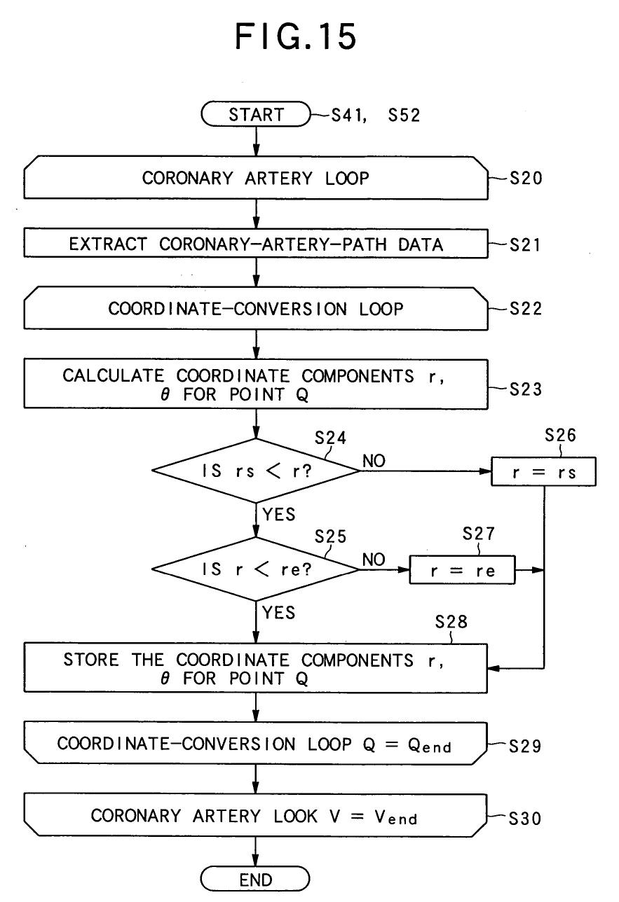

Next, The flowchart shown in FIG. 15 will be used to explain the operation of converting the path data to map coordinates to obtain the coronary-artery data C. The process described below is executed by the control unit 109 and other units based on control from the control unit 109.

First, the coronary-artery-path-data-extraction unit 108 extracts path data for the blood vessels (steps S20, S21).

Also, the control unit 109 starts the conversion process to convert all of the points Q of one blood vessel V path to bullseye map coordinates that are defined by the coordinates (r, θ). First, the control unit 109 calculates the coordinate components r and θ of the points Q of the blood vessel V path based on the extracted path data (step S23). When doing this, the calculated coordinate component r is compared with the heart apex rs (step S24) , and when r is less than or equal to the heart apex rs (step S24: NO), then r is taken to be rs (step S26), and when r is greater than the heart apex rs (step S24: YES), the process moves to step S25.

Also, the coordinate component r is compared with the heart base re (step S25) , and when r is greater than or equal to the heart base re (step S25: NO) , r is taken to be re (step S27) , and when r is. less than the heart base re, the calculated coordinate components r and θ are stored in the memory 101 (step S28). The process described above is performed for all of the points Q (step S29). Also, after the map coordinate components for all of the blood vessels V that were extracted in step S21 have been stored in the memory 101, processing ends (step S30).

In this way, coronary artery data C having map coordinates is obtained (see FIG. 14C).

(3) Overlay Process

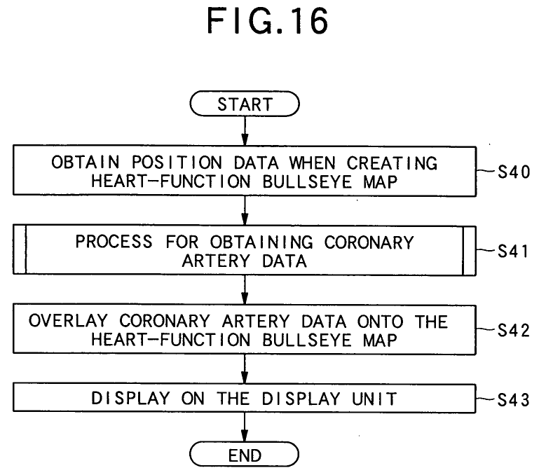

Next, the flowchart shown in FIG. 16 will be used to explain the operation of overlaying the obtained coronary artery data C onto heart-function bullseye map MS.

First, the overlay process in the case where both the heart-function bullseye map MS and the coronary artery data C are obtained based on the same 3-dimensional image data (image data) will be explained. The process described below is executed based on control from the control unit 109.

First, the control unit 109 uses the position data used when creating the heart-function bullseye map MS as reference position data (hereafter, referred to as reference position data) to obtain the coronary artery data C. More specifically, the control unit 109 obtains the major axis position data, the heart apex position data and the heart basal position data used when creating the heart-function bullseye map MS from the memory 101 (step S40).

Next, the control unit 109 uses the obtained reference position data to convert the coronary-artery-path data described above to map coordinates, and obtains the coronary artery data C (step S41).

Also, the control unit 109 overlays the obtained coronary artery data C onto the heart-function bullseye map MS (step S42), and displays the overlay result on the display unit 102 (step S43).

In the case where the heart-function bullseye map MS and coronary artery data C are obtained based on the same image data using this method, or in other words, in the case where the 3-dimensional image data Ha used for creating the heart-function bullseye map and the 3-dimensional image data Hb used for extracting the coronary-artery-path data as shown in FIG. 2B are the same, then both the patient coordinate system Ka and patient coordinate system Kb are the same and the overlay is performed accurately.

Next, the overlay process in the case where the heart-function bullseye map MS and the coronary artery data C are obtained based on 3-dimensional image data Ha and 3-dimensional image data Hb that are different will be explained.

In the case where coronary artery data is obtained using 3-dimensional data Hb that differs from the 3-dimensional data Ha used to create the heart-function bullseye map, it is necessary that the patient coordinate system Ka and patient coordinate system Kb are made to match such that the obtained coronary artery data is overlaid onto the heart-function bullseye map enough so that diagnosis is possible.

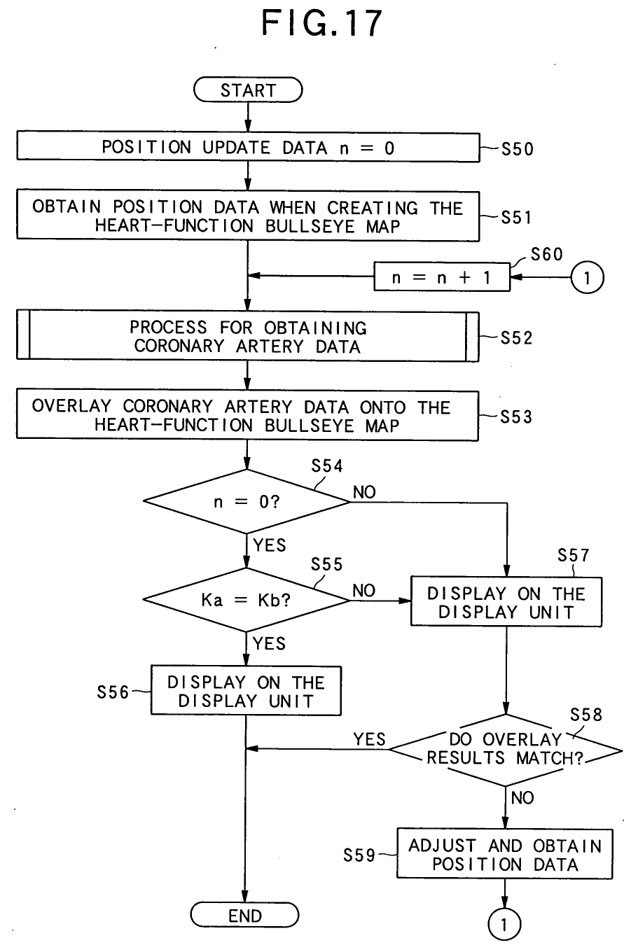

Below, the flowchart shown in FIG. 17 will be used to explain the overlay procedure of adjusting the reference position data used in the process for obtaining coronary artery data and overlaying that coronary artery data. The process described below is executed by the control unit 109 and other units based on control from the control unit 109.

First, the control unit 109 stores the position update data n as ‘0’ in the memory 101 (step S50). Next, the control unit 109 obtains the major axis position data, heart apex position data and heart basal position data used when creating the heart-function bullseye map MS from the memory 101 as reference position data (hereafter, referred to as reference position data) (step S51).

Also the control unit 109 uses the obtained reference position data to convert the coronary-artery-path data described above to map coordinates, and performs the process for obtaining the coronary artery data C (step S52).

Moreover, the control unit 109 overlays the obtained coronary artery data C onto the heart-function bullseye map MS (step S53).

Next, the control unit 109 determines whether or not the position-data-update data n described above is ‘0’ (step S54). When the judgment result is that the position-data-update data n is not ‘0’, the control unit 109 moves to step S57, and when the position-data-update data n is ‘0’ (step S54: YES), the control unit 109 determines whether or not the patient coordinate system Kb of the 3-dimensional image data Hb used when extracting the coronary-artery-path data matches the patient coordinate system Ka of the 3-dimensional image data Ha used when obtaining the heart-function bullseye map MS (step S55) , and when both of the patient coordinate systems match (step S55: YES), overlay is performed accurately and is displayed on the display unit 102, and processing ends (step S56).

In other words, regardless of whether or not the heart-function bullseye map MS and the coronary artery data C are obtained based on the same image data, by determining whether or not the patient coordinate systems match it is possible to determine whether or not overlay will be performed accurately.

On the other hand, when the patient coordinate system Kb of the 3-dimensional image data Hb used when extracting the coronary-artery-path data and the patient coordinate system Ka of the 3-dimensional image data Ha used when obtaining the heart-function bullseye map MS do not match (step S55: NO) , the control unit 109 displays the result of overlaying the coronary artery data C onto the heart-function bullseye map MS using the display unit (step S57).

Also, the position-data-adjustment unit 103 determines whether or not the overlay result matches, or in other words, determines whether or not the positional relationship between the heart-function bullseye map MS and coronary artery data C is proper or not based on the position-adjustment data stored in the memory 101 (step S58).

When it is determined that the positional relationship between the heart-function bullseye map MS and the coronary artery data C matches well enough for diagnosis to be possible (step S58: YES) , processing ends, however, when it is determined that the positional relationship between the heart-function bullseye map MS and the coronary artery data C does not match well enough for diagnosis to be possible (step S58: NO), the position-data-adjustment unit 103 adjusts the reference position data and obtains new updated reference position data (step S59). Also, after adding 1 to the position update data n, the control unit 109 moves to steps S52, and obtains coronary artery data C again based on the newly obtained updated reference position data (step S60).

With the operation described above, even though the heart-function bullseye map MS and coronary artery data C are obtained based on different image data, and even though the patient coordinate systems of the heart-function bullseye map MS and coronary artery data C are different, by adjusting the reference position data it is possible to overlay and display the coronary artery data C on the heart-function bullseye map MS at an accurate position, and thus it becomes possible to know at a glance the relative relationship between the condition of the heart and the coronary arteries.

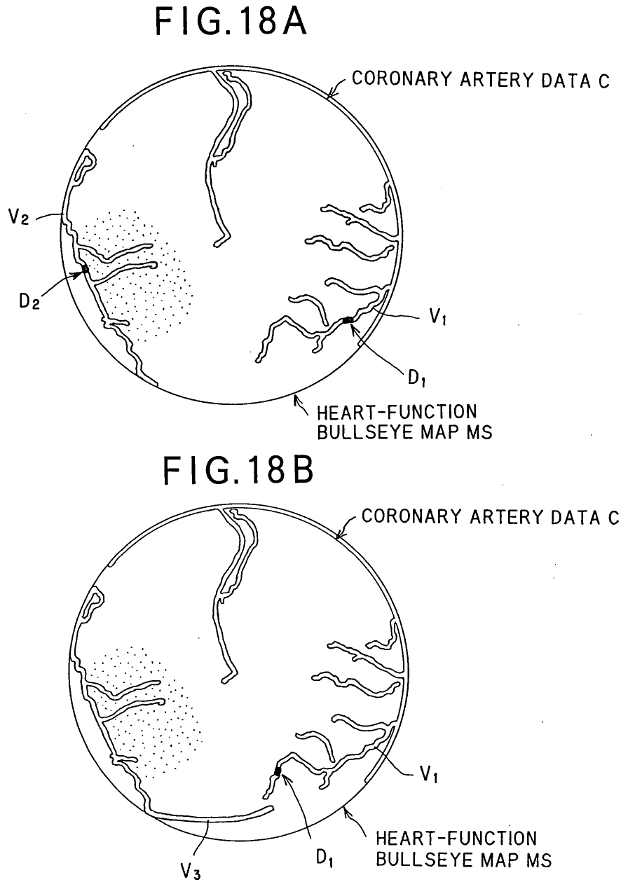

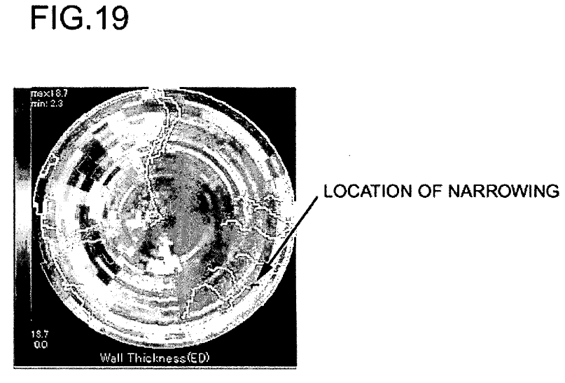

FIG. 18A and FIG. 18B are explanation drawings of overlay results, and FIG. 19 is one example of a display image on the display unit 102 that displays the overlay result.

For example, the location indicated by the dot pattern on the heart-function bullseye map MS in FIG. 18A is an area of abnormal function. In the figure, narrowing is discovered at point D₁ in blood vessel V₁ and point D₂ in blood vessel V₂, however, only a decrease in function due to the narrowing at point D₂ is confirmed on the heart-function bullseye map MS.

In other words, it is possible to determine that no decrease in function has occurred due to narrowing at point D₁ in blood vessel V₂, and in this kind of case, it is possible to properly determine whether to perform improvement or treatment of the narrowing location D₂ in blood vessel V₂.

Also, as shown in FIG. 18B, narrowing is discovered at point D₁ in blood vessel VI, however, there is no area of abnormal function near this point D₁ on the heart-function bullseye map MS. Also, when checking the coronary artery data C, it is possible to determine that no decrease in heart function has occurred due to the narrowing at this point D₁ because of the compensation of blood near point D₁ in blood vessel V₁ by blood vessel V₃. This also makes it possible to determine that operating is not necessary, so it is effective in avoiding the need of placing a burden on the patient.

In this embodiment of the invention, after the result of overlaying the coronary artery data C onto the heart-function bullseye map MS has been displayed on the display unit 102 in step S57, whether or not the overlay result is proper or not is determined based on the position adjustment data in step S58, however, when performing early determination of the positional relationship based on position adjustment data according to control from the control unit 109, the processing of step S57 does not need to be performed.

However, in another example, it is also possible for the user to visually check the results displayed on the display unit 102 in step S57 and determine whether or not the overlay results match, and use an input unit (not shown in the figures) to input an amount to adjust the position data.

Furthermore, in the embodiment described above, the position adjustment data is based on a characteristic area on the human body, however, as another example, it is possible to place an man-made landmark on the human body beforehand when performing imaging, and using that as the position-adjustment data.

Also, the display on the display unit 102 is not limited to the example shown in FIG. 18, for example, when an abnormal blood vessel such as narrowing at a location D, and areas of abnormal function on the heart-function bullseye map MS are close, and when there is a large possibility that an abnormal heart function is due to narrowing of a coronary artery, it is possible to use a notification device that displays that location of narrowing D or the area of abnormal function on the map using specified colors. In this case, definitions of abnormal areas, such as the distance between the abnormal area due to the narrow blood vessel and the abnormal area found on the heart-function bullseye map, or specified color data can be stored in the memory 101 beforehand. When doing this, measures can be taken such as lowering the tone of the entire image in order that the displayed color is more easily identified.

The aforementioned notification device is not limited to a color display, and could be constructed such that the abnormal area flashes, is highlighted, or such that a sound is output from a audio-output unit (not shown in the figures) when a cursor (not shown in the figures) moves over the abnormal area on the display screen. Also, when there is a notification, construction is also possible in which a specified abnormality warning message is sent to a specified e-mail address based on control from the control unit 109, and that message can be checked using a remote computer or portable terminal such as a portable telephone. When doing this, a new database is set up in the memory 101, and the abnormality warning messages and mail addresses can be saved in that database.

Also, since the function map contains time elements as described above, it is possible to check the operation over time by an animated display of the overlay results of the coronary artery data.

With this invention, by having an overlay device overlay tubular structure data such as coronary artery data onto a function map such as a heart-function bullseye map that is created by a function-map-creation device, it is possible to easily know which tubular structures such as blood vessels that surround an organ are supported by what locations of the organ, and thus it is possible to correlate and gain a better understanding of organ functions and tubular structure.

Moreover, by obtaining a function map and tubular structure data based on image data, it is possible to accurately correlate the tubular structure with the function map even though there are individual differences in the shape of tubular structure.

It should be understood that various alternatives to the embodiment of the invention described herein may be employed in practicing the invention. Thus, it is intended that the following claims define the scope of the invention and that methods and structures within the scope of these claims and their equivalents be covered thereby.

The entire disclosure of Japanese Patent Application No. 2003-272976 filed on Jul. 10, 2003, including specification, claims, drawings and summary are incorporated herein by reference in its entirety.

Each meaning of the reference number in the drawings are as follows:

100:Image-analysis apparatus, 101:Memory, 102:Display unit (display device), 103:Position-data-adjustment unit (adjustment device) , 104: Coordinate-conversion-display unit, 105: Heart-function-indicator-definition-creation unit (function setting device), 106: Heart-function-bullseye-map-coordinate-table-creation unit (function setting device), 107: Heart-function-bullseye-map-creation unit (function-map-creation device), 108: Coronary-artery-path-data-extraction unit (overlay device) 109: Control unit (function-map-creation device, overlay device, function-setting device, display device, first and second judgment device, adjustment device, abnormality-notification device, computer), MS: Heart-function bullseye map, M: Bullseye map, H4D: 4-dimensional image data (image data) , H: 3-dimensional image data (image data) , Ha: 3-dimensional image data used in creation of the heart-function bullseye map, Hb: 3-dimensional image data used in extraction of the coronary-artery-path data, P: Phase, Xⁱⁿ: Inner myocardial wall position data, X^{out}: Outer myocardial wall position data, U(m, n) : Map position data, α: Heart function indicator, D: Abnormal blood vessel, V: Blood vessel, C: Coronary artery data (tubular structure data) , n: Position-update data, Ka: Patient coordinate system used in creation of the heart-function bullseye map, and Kb: Patient coordinate system used in extraction of the coronary-artery-path data.

1. An image-analysis apparatus that performs image analysis based on image data, and comprising:
a function-map-creation device which creates a function map based on function data that show the functions of an organ; and
an overlay device which correlates and overlays tubular-structure data for the tubular structure of said organ onto said function map.

2. The image-analysis apparatus of claim 1 further comprising
a function-setting device which sets said function data based on first data that contains voxel data for the voxels of said organ, and position data showing the position of the voxels; and wherein
said function-map creation device creates said function map based on reference-position data for said organ and said function data that was set by said function-setting device; and
said overlay device obtains and overlays said tubular-structure data based on second data that contains path data showing the path of said tubular structure, and said reference-position data.

3. The image-analysis apparatus of claim 2 further comprising:
a first judgment device which determines whether or not said first data and said second data were obtained based on the same image data; and
a display device which displays the overlay results of said overlay device; and wherein
said display device displays said overlay results when it is determined by said first judgment device that said first and second data were obtained based on the same image data.

4. The image-analysis apparatus of claim 3 further comprising:
a second judgment device which determines whether or not adjustment of said reference-position data is necessary; and wherein
said display device displays said overlay results when it is determined by said second judgment device that adjustment of said reference-position data is not necessary.

5. The image-analysis apparatus of claim 4 further comprising:
an adjustment device which adjusts said reference-position data and obtaining updated reference-position data; and wherein
said adjustment device obtains said updated reference-position data when it is determined by said second judgment device that adjustment of said reference-position data is necessary; and
said overlay device obtains and overlays said tubular-structure data again based on said updated reference-position data.

6. The image-analysis apparatus of claim 5 wherein
said adjustment device obtains said updated reference-position data based on position-adjustment data that was obtained based on image data for said organ and said tubular structure.

7. The image-analysis apparatus of claim 1 further comprising
an abnormality-notification device which notifies of abnormalities based on the overlay results by said overlay device, abnormal areas in said tubular structure indicated by said tubular-structure data, and areas of abnormal function indicated by said function map.

8. The image-analysis apparatus of claim 1 wherein
said function map is a bullseye map.

9. The image-analysis apparatus of claim 1 wherein
said function map is a 3D polygon model.

10. A recording medium on which an image-analysis program is recorded such that it can be read by a computer that is included in an image-analysis apparatus that performs image analysis based on image data, and makes said computer function as:
a function-map-creation device which creates a function map based on function data that show the functions of an organ; and
an overlay device which correlates and overlays tubular-structure data for the tubular structure of said organ onto said function map.

11. The recording medium of claim 10 on which an image-analysis program is recorded, wherein
said image-analysis program further makes said computer function as:
a function-setting device which sets said function data based on first data that contains voxel data for the voxels of said organ, and position data showing the position of the voxels; and causes
said function-map creation device to create said function map based on reference-position data for said organ and said function data that was set by said function-setting device; and causes
said overlay device to obtain and overlay said tubular-structure data based on second data that contains path data showing the path of said tubular structure, and said reference-position data.

12. The recording medium of claim 11 on which an image-analysis program is recorded, wherein
said image-analysis program further makes said computer function as:
a first judgment device which determines whether or not said first data and said second data were obtained based on the same image data; and
a display device which displays the overlay results of said overlay device; and causes
said display device to display said overlay results when it is determined by said first judgment device that said first and second data were obtained based on the same image data.

13. The recording medium of claim 12 on which an image-analysis program is recorded, wherein
said image-analysis program further makes said computer function as:
a second judgment device which determines whether or not adjustment of said reference-position data is necessary; and causes
said display device to display said overlay results when it is determined by said second judgment device that adjustment of said reference-position data is not necessary.

14. The recording medium of claim 13 on which an image-analysis program is recorded, wherein
said image-analysis program further makes said computer function as:
an adjustment device which adjusts said reference-position data and obtaining updated reference-position data; and causes
said adjustment device to obtain said updated reference-position data when it is determined by said second judgment device that adjustment of said reference-position data is necessary; and causes
said overlay device to obtain and overlay said tubular-structure data again based on said updated reference-position data.

15. The recording medium of claim 13 on which an image-analysis program is recorded, wherein
said image-analysis program causes said adjustment device to obtain said updated reference-position data based on position-adjustment data that was obtained based on image data for said organ and said tubular structure.

16. The recording medium of claim 10 on which an image-analysis program is recorded, wherein
said image-analysis program further makes said computer function as:
an abnormality-notification device which notifies of abnormalities based on the overlay results by said overlay device, abnormal areas in said tubular structure indicated by said tubular-structure data, and areas of abnormal function indicated by said function map.

17. The recording medium of claim 10 on which an image-analysis program is recorded, wherein
said function map is a bullseye map.

18. The recording medium of claim 10 on which an image-analysis program is recorded, where
said function map is a 3D polygon model.

19. An image-analysis method of performing image analysis based on image data, and comprising:
a function-setting process for setting function data that shows the function of an organ based on first data that contains voxel data for the voxels of said organ, and position data showing the position of the voxels;
a function-map-creation process for creating a function map based on said function data that shows the functions of said organ;
a tubular-structure-acquisition process for obtaining tubular-structure data based on second data that contains path data that indicates the path of the tubular structure in said organ; and
an overlay process for correlating and overlaying said tubular-structure data onto said function map.

20. The image-analysis method of claim 19 further comprising:
a first judgment process for determining whether or not said first data and said second data were obtained based on the same image data; and
a display process for displaying the overlay results of said overlay process when it is determined by said first judgment process that said first and second data were obtained based on the same image data.

21. The image-analysis method of claim 20 further comprising
a second judgment process for determining whether or not adjustment of said reference-position data is necessary; and wherein
said display process displays said overlay results when it is determined by said second judgment process that adjustment of said reference-position data is not necessary.

22. The image-analysis method of claim 21 further comprising
an adjustment process for adjusting said reference-position data and obtaining updated reference-position data when it is determined by said second judgment process that adjustment of said reference-position data is necessary; and wherein
said overlay process obtains and overlays said tubular-structure data again based on said updated reference-position data.

23. The image-analysis method of claim 22 wherein
said adjustment process obtains said updated reference-position data based on position-adjustment data that was obtained based on image data for said organ and said tubular structure.

24. The image-analysis method of claim 19 further comprising
an abnormality-notification process for notifying of abnormalities based on the overlay results by said overlay process, abnormal areas in said tubular structure indicated by said tubular-structure data, and areas of abnormal function indicated by said function map.

25. The image-analysis method of claim 19 wherein
said function map is a bullseye map.

26. The image-analysis method of claim 19 wherein
said function map is a 3D polygon model.
